(19) United States
(12) Patent Application Publication
(10) Pub. No.: US 2017/0321657 A1
(43) Pub. Date: Nov. 9, 2017

(54) POWER GENERATION SYSTEM UTILIZING TURBINE ARRAYS

(71) Applicant: Dustin Clemo, Reno, NV (US)

(72) Inventor: Dustin Clemo, Reno, NV (US)

(21) Appl. No.: 15/147,740

(22) Filed: May 5, 2016

(51) Int. Cl. F03D 9/25; H02K 7/18; F03D 3/06; F03D 3/00; F01K 7/16; F03B 13/10; F03D 3/02; F01D 15/10

(52) U.S. Cl. CPC F03D 9/255; H02K 7/183; H02K 7/1823; F03D 3/062; F01D 15/10; F01K 7/16; F03B 13/10; F03D 9/257; F03D 3/02; F03D 3/005; F05B 2220/32; F05B 2220/7068; F05D 2220/31; F05D 2220/768

(57) ABSTRACT

A system for generating power from turbine arrays comprises a plurality of turbines positioned in a turbine array. Each turbine comprises a vertical shaft having an upper portion, a middle portion and a lower portion. The lower portion of the shaft is attached to a base member housing at a top portion thereof utilizing a lower shaft bearing. Thus, the shaft is configured to rotate and move linearly in an axial direction. Each turbine further comprises a turbine head having blades mounted at the upper portion of the shaft utilizing an upper shaft bearing and a first pulley coupled with a gear connected to the middle portion of the shaft. The system further comprises a generator having a second pulley that is engaged with the first pulley utilizing a coupling means. When the shaft rotates, the first and second pulleys turn to actuate the generator thereby generating electrical current.

### RELATED APPLICATIONS

Not Applicable.

### TECHNICAL FIELD OF THE DISCLOSURE

The present embodiment relates in general to systems for electricity production. More specifically, the present disclosure relates to a system for generating power utilizing turbine arrays.

### BACKGROUND OF THE DISCLOSURE

Alternative energy sources provide an attractive solution to today's growing demand for energy. Alternative energy sources are a clean source of energy that protect the environment against the release of harmful by-products such as greenhouse gasses into the atmosphere. There are many alternative energy sources such as wind energy, solar energy, biogas/biomass, energy from waste and other alternative sources of energy for example, fuel cell, hydrogen energy, tidal, geothermal, etc.

Wind and water turbines have gained widespread use for electricity generation in recent years. These turbines operate by transferring the motion of wind/water into the rotation of turbine blades around a horizontal or vertical axis. The turbine blades are connected to a generator that converts the mechanical kinetic energy of rotation into electrical energy. The conversion of energy from a fluid flow, such as from the wind/water, to electrical energy has typically been implemented with large singular horizontal axis turbines. The energy conversion efficiency for such a configuration is low. Also, there are several technical issues such as turbine size, number of turbines, arrangement of turbines and deflation of the blades that adversely affect the economics of wind energy.

Another problem with traditional turbines is that these turbines cannot produce varying electrical currents at varying wind/water speeds. The turbine arrangement and deflation of blades do not provide the most efficient aerodynamic performance. Another issue experienced by these turbines is that they cannot be used for both on-grid and off-grid applications.

As well, existing turbine systems are unable to generate power with low wind.

Existing turbine systems are not adaptable to mount on a roof structure.

Existing turbine systems do not include an independent turbine system.

Existing turbine systems do not generate power efficiently from all wind angles.

Existing turbine systems can be noisy while operating.

Existing turbine systems pose a danger to wild life especially birds.

According to the American Bird Conservatory, the annual loss of birds from wind turbines was estimated at 573,000 in 2012. However, vastly more turbines are in operation now, and more than 1.4 million bird deaths are projected by 2030 or earlier if the U.S. meets its goal of producing 20 percent of electrical energy with wind. If that figure reaches 35 percent, as new Department of Energy projections suggest, up to 5 million birds could be killed annually.

Therefore, there is a strong but yet unmet need for an economic, environmental friendly and lightweight system that would efficiently generate power utilizing turbine arrays. Such a system would include a sealed housing for protecting the generator and other turbine parts from harsh weather and water. This system would be able to generate power with low wind, be adaptable to mount on a roof structure, and generate power efficiently from any wind angle. Such a system could produce varying electrical currents at varying wind/water speeds. It would include an independent turbine arrangement that provides easy access and replacement of the turbine when it is damaged without affecting any other parts of the system. Such a system would be used for both on-grid and off-grid applications, and capable of being installed in small areas. Further, this system would be customizable and stackable to reduce its deployment area, and operate with reduced noise. Finally, this system would be safe and designed to function on any axis and fit for installation on an existing structure.

### SUMMARY OF THE DISCLOSURE

To minimize the limitations found in the prior art, and to minimize other limitations that will be apparent upon the reading of the specifications, preferred embodiment of the present invention provides a system for efficiently generating power utilizing turbine arrays. The system comprises a plurality of turbines positioned in at least one turbine array of the plurality of turbine arrays. Each turbine comprises a vertical shaft having an upper portion, a middle portion and a lower portion. The lower portion of the vertical shaft is attached to a base member housing at a top portion thereof utilizing a lower shaft bearing. Thus, the vertical shaft is configured to rotate and move linearly in an axial direction. Each turbine further comprises a turbine head having a plurality of blades mounted at the upper portion of the vertical shaft utilizing an upper shaft bearing and a first pulley coupled with a gear connected to the middle portion of the vertical shaft. The system further comprises a generator having a second pulley connected at a top portion thereof and coupled to each turbine. The second pulley is engaged with the first pulley utilizing at least one coupling means. The at least one coupling means is a drive v-belt. When the vertical shaft rotates, the first and second pulleys turn to actuate the generator thereby generating electrical current. In the preferred embodiment, the generator is a permanent magnet generator that is adaptable to convert rotational movement into electrical power.

The rotation of the vertical shaft drives the first pulley, which drives the at least one coupling means, which in turn drives the second pulley attached to the generator. Thus, the second pulley spins the generator. As the generator rotates, it generates electrical power, which may then be supplied to one or more loads.

Each blade includes an interior portion and an exterior portion. The interior portion is straight and the exterior portion is arced. The plurality of blades is disposed equally about a circumference of the vertical shaft and each blade includes identical shape and orientation. Preferably, the lower shaft bearing is a flanged linear ball bearing and the upper shaft bearing is a pillow block bearing. The base member housing further comprises at least one electrical connection means to electrically connect the generator to an electrical grid working with a transformer. The system further comprises a wiring channel along the at least one turbine array, which is configured to receive a wire that conductively connects the generator to the electrical grid working with the transformer via the at least one electrical connection means mounted at the base member housing, thereby forming an electrical circuit and allowing the electrical current generated by the generator to be collected and distributed. The at least one turbine array of the plurality of turbine arrays is enclosed in a screened turbine housing. The screened turbine housing is connected to a wire mesh housing by a screened turbine housing mount. The wire mesh housing seals the screened turbine housing to prevent wear and tear of the plurality of turbines. The maintenance and replacement of each turbine can be performed by removing a screened turbine housing lid of the screened turbine housing. The plurality of turbines is selected from a group consisting of: wind turbines, water turbines and steam turbines. The plurality of turbine arrays is mounted together to form an elongated erect structure in a shape of a tree.

The system further comprises a sealed component housing that is configured to enclose the first and second pulleys, the generator and the lower portion of the vertical shaft thereby leaving the plurality of blades of the turbine head exposed. The sealed component housing is attached to a sloped maintenance lid utilizing at least one fastening means for allowing the maintenance of the first and second pulleys, the generator and the lower portion of the vertical shaft.

A first objective of the present invention is to provide an economic, environmental friendly and lightweight system that efficiently generates power utilizing turbine arrays.

A second objective of the present invention is to provide a sealed housing for protecting the generator and other turbine parts from harsh weather and water.

A third objective of the present invention is to provide a system that is able to generate power with low wind, adaptable to mount on a roof structure, and generate power efficiently from any wind angle.

A fourth objective of the present invention is to provide a system that produce varying electrical currents at varying wind/water speeds.

A fifth objective of the present invention is to provide a system that includes an independent turbine arrangement which provides easy access and replacement of the turbine when it is damaged without affecting any other parts of the system.

A sixth objective of the present invention is to provide a system that is used for both on-grid and off-grid applications, and capable of being installed in small areas.

A seventh objective of the present invention is to provide a system that is customizable and stackable to reduce its deployment area, and operate with reduced noise.

Another objective of the present invention is to provide a system that is safe and designed to function on any axis and fit for installation on an existing structure.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a side elevational view of at least one turbine and a generator of a system for generating power from a plurality of turbine arrays in accordance with the preferred embodiment of the present invention;

FIG. 2 illustrates a perspective view of the at least one turbine and the generator of the system for generating power from the plurality of turbine arrays shown in FIG. 1;

FIG. 3 illustrates a schematic view of an array of the turbines and generators shown in FIG. 1 arranged vertically in accordance with the preferred embodiment of the present invention;

FIG. 4A illustrates a schematic view of the system for generating power from the plurality of turbine arrays in accordance with the preferred embodiment of the present invention;

FIG. 4B illustrates a partial schematic view, showing position of components within the array shown in FIG. 4A in accordance with the preferred embodiment of the present invention;

FIG. 5A illustrates a side elevational view of the system for generating power from the plurality of turbine arrays shown in FIG. 4A in accordance with the preferred embodiment of the present invention; and

FIG. 5B illustrates a partial side elevational view of the system for generating power from the plurality of turbine arrays shown in FIG. 5A in accordance with the preferred embodiment of the present invention.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

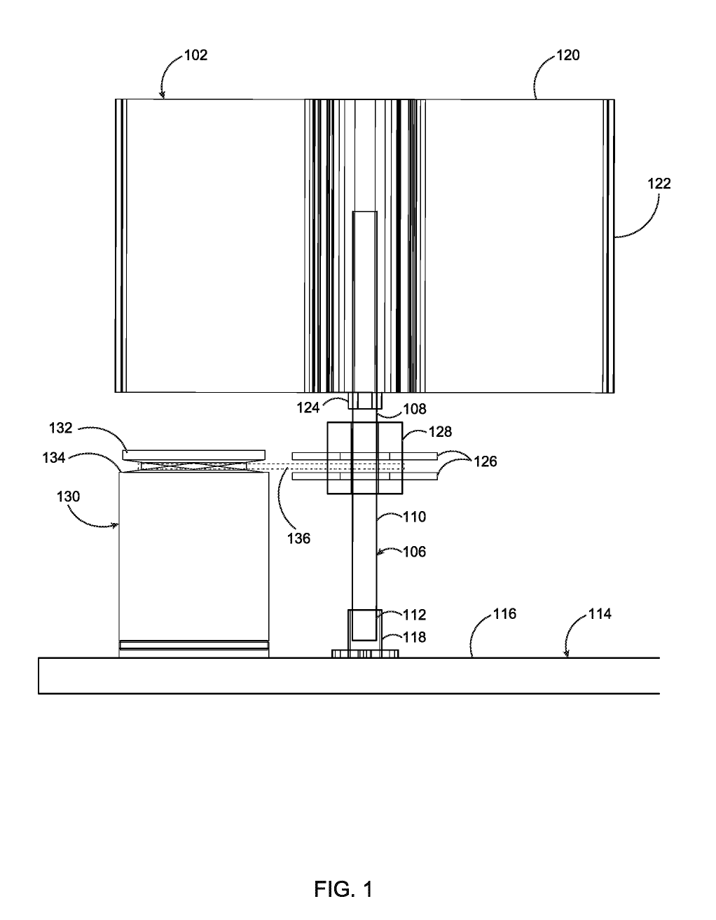

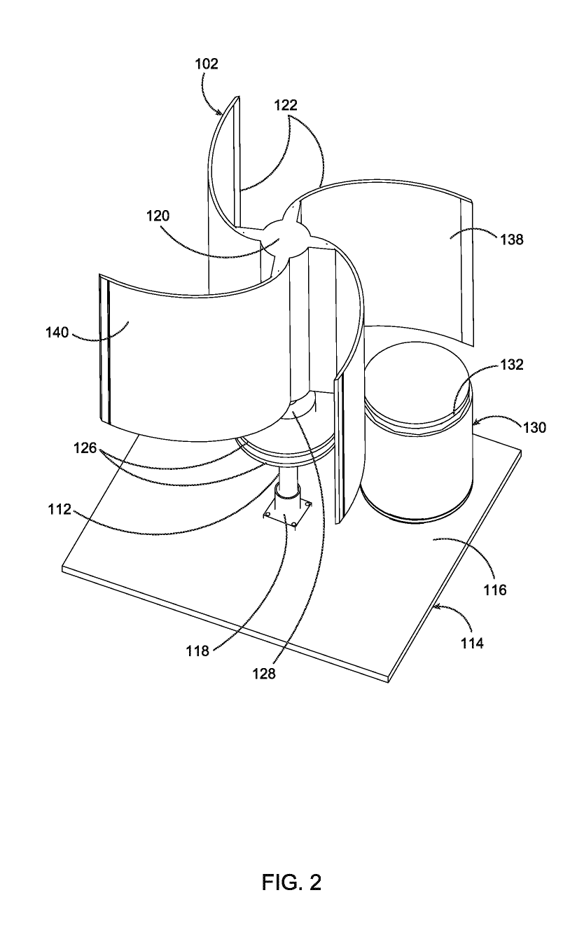

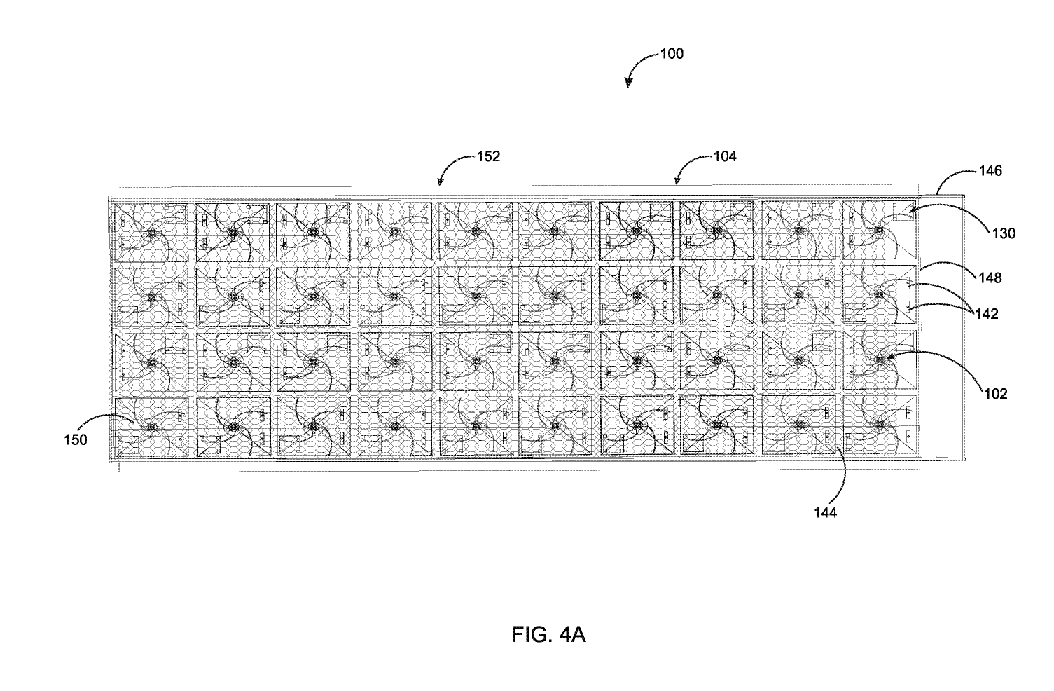

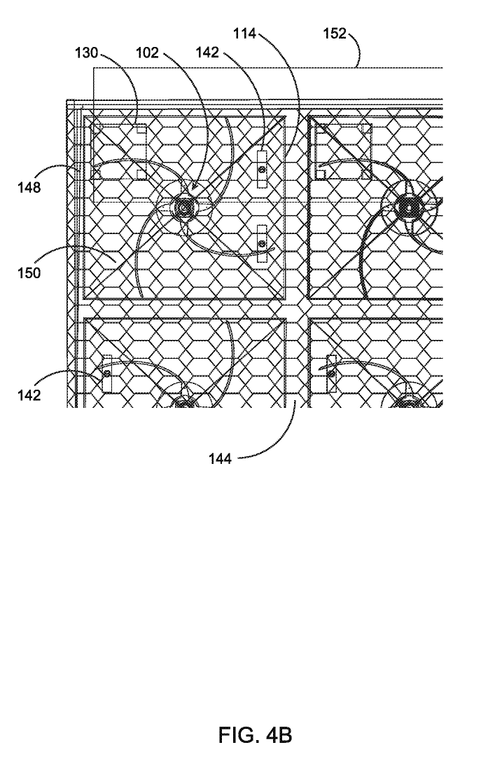

Turning first to FIGS. 1 and 2, a side elevational view and a perspective view of at least one turbine and a generator of a system for generating power from a plurality of turbine arrays in accordance with the preferred embodiment of the present invention are illustrated. The system 100 comprises a plurality of turbines 102 positioned in at least one turbine array 104 (See FIG. 4A) of the plurality of turbine arrays. Each turbine 102 comprises a vertical shaft 106 having an upper portion 108, a middle portion 110 and a lower portion 112. The lower portion 112 of the vertical shaft 106 is attached to a base member housing 114 at a top portion 116 thereof utilizing a lower shaft bearing 118. Thus, the vertical shaft 106 is configured to rotate and move linearly in an axial direction. Each turbine 102 further comprises a turbine head 120 having a plurality of blades 122 mounted at the upper portion 108 of the vertical shaft 106 utilizing an upper shaft bearing 124 and a first pulley 126 coupled with a gear 128 connected to the middle portion 110 of the vertical shaft 106. The system further comprises a generator 130 having a second pulley 132 connected to a top portion 134 thereof and coupled to each turbine 102. The second pulley 132 is engaged with the first pulley 126 utilizing at least one coupling means 136. The at least one coupling means 136 is a drive v-belt. The first and second pulleys 126, 132 have three-inch circumference. When the vertical shaft 106 rotates, the first and second pulleys 126, 132 turn to actuate the generator 130 thereby generating electrical current. In the preferred embodiment, the generator 130 is a permanent magnet generator that is adaptable to convert rotational movement into electrical power.

The rotation of the vertical shaft 106 drives the first pulley 126, which drives the at least one coupling means 134, which in turn drives the second pulley 132 attached to the generator 130. Thus, the second pulley 132 spins the generator 130. As the generator 130 rotates, it generates electrical power, which may then be supplied to one or more loads.

Each blade 122 shown in FIG. 2 includes an interior portion 138 and an exterior portion 140. The interior portion 138 is straight and the exterior portion 140 is arced. The plurality of blades 122 is disposed equally about a circumference of the vertical shaft 106 and each blade 122 includes identical shape and orientation. Preferably, each turbine 102 includes 4 blades. In the preferred embodiment, the plurality of blades 122 is made of recycled acrylonitrile butadiene styrene (ABS) plastics. The plurality of blades 122 can be configured in a desired orientation to operate in Dutch windmill.

Preferably, the lower shaft bearing 118 is a flanged linear ball bearing and the upper shaft bearing 124 is a pillow block bearing. The base member housing 114 further comprises at least one electrical connection means 142 (See FIG. 4A) to electrically connect the generator 130 to an electrical grid (not shown) working with a transformer (not shown).

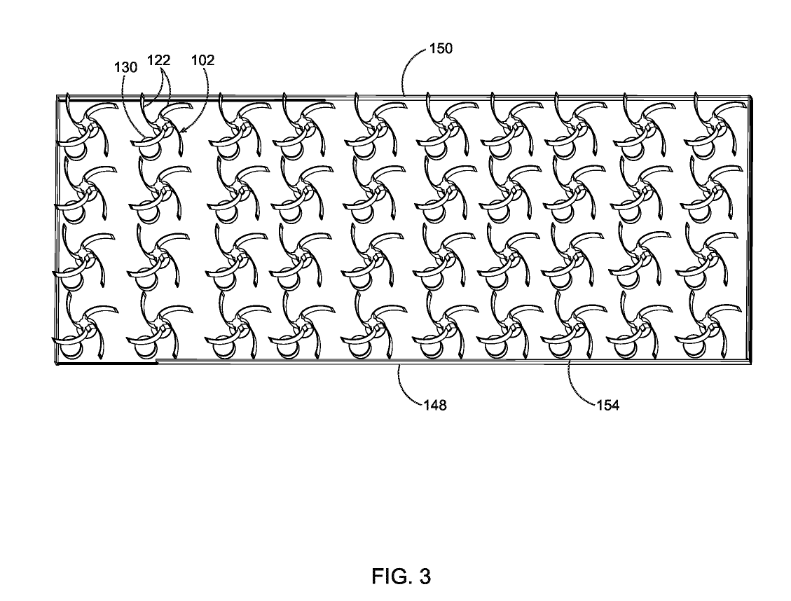

FIG. 3 illustrates a schematic view of an array of the plurality of turbines and generators shown in FIG. 1 arranged vertically in accordance with the preferred embodiment of the present invention. The at least one turbine array 104 of the plurality of turbine arrays is enclosed in a screened turbine housing 148. The screened turbine housing 148 is connected to a wire mesh housing 150 by a screened turbine housing mount 152 (See FIG. 4B). The wire mesh housing 150 seals the screened turbine housing 148 to prevent wear and tear of the plurality of turbines 102. The maintenance and replacement of each of the turbine 102 can be performed by removing a screened turbine housing lid 154 of the screened turbine housing 148. The plurality of turbines 102 is selected from a group consisting of: wind turbines, water turbines and steam turbines. The generator 130 includes a length of less than about 80 mm and a width of less than about 60 mm. The generator 130 provides an output of at least 12 volts when the generator 130 is revolving at 2000 rotations per minute. The amount of torque need to start the generator 130 is less than 500 grams per centimeter.

FIGS. 4A and 4B illustrate schematic views showing position of the components within the at least one turbine array 104 in accordance with the preferred embodiment of the present invention. The plurality of turbines 102 is arranged vertically in the at least one turbine array 104. The system 100 further comprises a sealed component housing 146 that is configured to enclose the first and second pulleys 126, 132, the generator 130 and the lower portion 112 of the vertical shaft 106 thereby leaving the plurality of blades 122 of the turbine head 120 exposed. The system further comprises a wiring channel 144 along the at least one turbine array 104, which is configured to receive a wire that conductively connects the generator 130 to the electrical grid (not shown) working with the transformer (not shown) via the at least one electrical connection means 142 mounted at the base member housing 114, thereby forming an electrical circuit and allowing the electrical current generated by the generator 130 to be collected and distributed. The at least one turbine array 104 is enclosed in the screened turbine housing 148 which is connected to the wire mesh housing 150 for sealing the screened turbine housing 148 to prevent wear and tear of the plurality of turbines 102. The at least one turbine array 104 includes 40 turbines that are configured in 4 rows in such a way that each row having 10 turbines. The at least one turbine array 104 is oriented with at least a 10% pitch relative to a ground surface. The plurality of turbine arrays is mounted together to form an elongated erect structure in a shape of a tree.

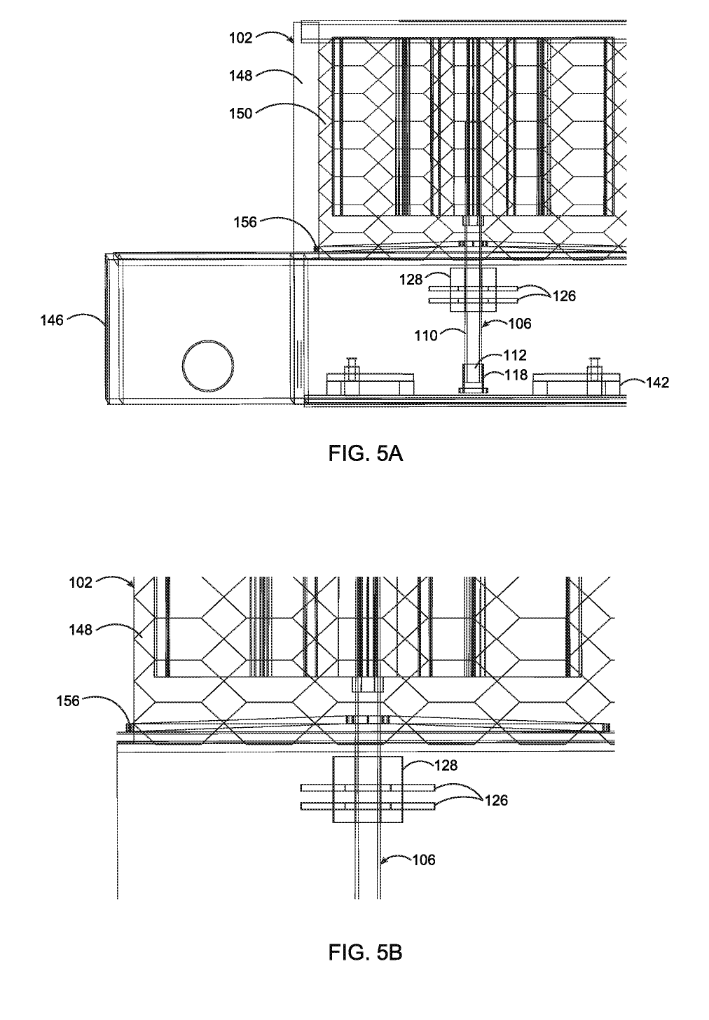

FIGS. 5A and 5B illustrate side elevational views of the system for generating power from the plurality of turbine arrays shown in FIG. 4A in accordance with the preferred embodiment of the present invention. The sealed component housing 146 is attached to a sloped maintenance lid 156 utilizing at least one fastening means for allowing the maintenance of the first and second pulleys 126, 132, the generator 130 and the lower portion 112 of the vertical shaft 106. The at least one fastening means is of the type typically known in construction/installation and may comprise a screw. Preferably, a rubber gasket or silicon washer is utilized for sealing the sloped maintenance lid 156 through which the at least one fastening means is fitted, so as to protect the first and second pulleys 126, 132, the generator 130 and the lower portion 112 of the vertical shaft 106 from harsh weather and prevent seepage of water.

The presently disclosed system is advantageous because it is safe and lightweight. The system 100 is capable to generate power with low wind and generate power efficiently from any wind angle. The preferred embodiment is adaptable to mount on a roof structure and designed to function on any axis, and fit for installation on an existing structure. The system 100 is configured to produce varying electrical currents at varying wind/water speeds. The system 100 comprises an independent turbine arrangement that provides easy access and replacement of each turbine 102 when it is damaged without affecting any other parts of the system 100. The system 100 is used for both on-grid and off-grid applications and capable of being installed in small areas. Further, the system 100 is customizable and stackable to reduce its deployment area, and operate with reduced noise. Most of the essential components of the system 100 may be made from recycled materials that are entirely biodegradable.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the system 100 may be constructed with different shapes and sizes of blades and different arrangement of turbine arrays for increasing the electrical output. It is intended that the scope of the present invention not be limited by this detailed description, but by the claims and the equivalents to the claims appended hereto.

What is claimed is:

1. A system for the generation of electricity comprising:
a. a plurality of independent turbines configured in at least one array;
b. each turbine is coupled with a permanent magnet generator such that rotation each of the turbine actuates the generator.

2. The system of claim 1, wherein each turbine has 4 blades.

3. The system of claim 1, wherein:
a. each turbine comprises a turbine head mounted to a shaft;
b. the turbine head comprises an upper portion of the shaft with the 4 blades attached about the shaft;
c. the system further includes a gear connected to a middle portion of the shaft;
d. the system further includes a first pulley connected to a middle portion of the shaft, and a second pulley connected to the generator;
e. the system further includes a belt coupled to the first pulley and the second pulley such that the generator is driven when the shaft rotates;
f. the generator and the pulley are enclosed in a weather-proof electrical housing thereby leaving only the turbine head expose to natural elements;
g. a lower portion of the shaft is connected to a flange linear ball bearing;
h. the flange linear ball bearing is affixed to the electrical housing.

4. The system of claim 3, further including a sloped maintenance lid configured to attach to and remove from the electrical housing;

5. The system of claim 3, wherein each generator is connected to an electrical bridge and the electrical bridge is connected to a transformer, thereby allowing the electricity generated by each generator to be collected and distributed.

6. The system of claim 3, wherein the sloped maintenance lid is coupled to the container by a pillow block bearing with 2 or more set screws.

7. The system of claim 1, wherein the array has 40 turbines configured in 4 rows of 10 turbines each.

8. The system of claim 1, wherein the array is oriented with at least a 10% pitch relative to a ground surface.

9. The system of claim 2, wherein the blades are disposed equally about a circumference of the shaft.

10. The system of claim 9, wherein:
a. the blades include an interior portion connected to the shaft and an exterior portion;
b. the interior portion is straight and the exterior portion is arced;
c. each blade is arced with identical orientation;
d. each blade has identical shape.

11. The system of claim 1, wherein the plurality of turbines comprise wind turbines.

12. The system of claim 1, wherein the plurality of turbines comprise water turbines.

13. The system of claim 1, wherein a plurality of the arrays are mounted to an elongated erect structure in a shape that resembles a tree.

14. The system of claim 1, wherein the array is encased in screened housing.

15. The system of claim 3, wherein the dimension of the generator is not greater than 80 millimeters long and 60 millimeters wide.

16. The system of claim 15, wherein the generator has an output of at least 12 volts when the generator is revolving at 2000 rotations per minute.

17. The system of claim 15, wherein an amount of torque need to start the generator is not greater than 500 grams per centimeter.

18. The system of claim 3, wherein belt comprises a v-belt.

19. The system of claim 18, wherein pulley has a 3 inch circumference.

20. The system of claim 3, wherein the blades are made of recycled ABS plastic.

21. The system of claim 3, wherein the blades are configured in a dutch windmill orientation.
